(19) United States
(12) Patent Application Publication
(10) Pub. No.: US 2016/0130853 A1
(43) Pub. Date: May 12, 2016

(54) MOVABLE BARRIER OPERATOR WITH TOUCHSCREEN INTERFACE

(71) Applicant: VIKING ACCESS SYSTEMS, LLC, Irvine, CA (US)

(72) Inventor: ALI TEHRANCHI, IRVINE, CA (US)

(21) Appl. No.: 14/538,530

(22) Filed: Nov. 11, 2014

(51) Int. Cl. E05F 15/60; G06F 3/0488; G06F 3/041

(52) U.S. Cl. CPC E05F 15/60; G06F 3/0416; G06F 3/0488

(57) ABSTRACT

The present invention is generally a movable barrier operator with a touchscreen user interface, and more specifically, to a movable barrier operator that provides an integrated display for enabling a graphical user interface (GUI) that relays easy to use diagnostic or systemic information to a user. In one embodiment, the present invention involves a movable barrier operator with a touchscreen display that provides a GUI to enable installing, troubleshooting, or controlling the movable barrier operator. This touchscreen interface is implemented with the barrier operator and provides the advantage of displaying meaningful information without the need to use pseudo-words to communicate a message, a setting or an option to the user. In the same manner, the GUI offers the capability to present readable and meaningful messages in case of errors or malfunctions instead of displaying error codes or pseudo-language which inadequately describes these errors.

### TECHNICAL FIELD OF THE INVENTION

The present invention relates in general to a movable barrier operator with a touchscreen interface, and more specifically, to a movable barrier operator that provides an integrated touchscreen display and user interface to relay easy-to-use system set-up, configuration, diagnostic or otherwise systemic information to a user.

### COPYRIGHT & TRADEMARK NOTICE

A portion of the disclosure of this patent application may contain material that is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and shall not be construed as descriptive or to limit the scope of this invention to material associated only with such marks.

### BACKGROUND OF THE INVENTION

Typically, technicians in the movable barrier industry are required to perform certain installations, maintenance or repairs on movable barrier operators in the field. This responsibility requires each technician to perform tasks such as setting barrier limits, monitoring power diagnostics, or otherwise diagnosing and troubleshooting an operator's components. Often, technicians performing such regular maintenance or repairs must access operators by removing operator covers or housings and connect one or more devices to the operator in order to service the equipment. This requires technicians that are trained with the skill and know-how to inspect or otherwise work on the apparatus. Furthermore, in order to gain access to the internal components of operators in the field, technicians must also be trained to use various tools, such as voltmeters, amp-meters, ohmmeters and so forth, which are typically required to test and troubleshoot operator systems and system components. Moreover, technicians must be familiarized with the particular models being serviced; this often requires specific training in order for the technician to adequately and efficiently identify the specific knobs, button, switches, or controls that may require adjusting.

Service providers, such as manufacturers, installers and distributors of operators, must therefore spend time and other valuable resources in acquiring the necessary equipment to service operators in the field. Furthermore, service providers must train personnel to service operators properly, including educating technicians with the required know-how to utilize tools and instruments used to measure, calibrate and otherwise perform maintenance on the operators.

Therefore, there is a need in the art for a more efficient and convenient means of enabling service providers to offer services to operators in the field that permit less expenditure on training and equipment. Furthermore, there is a need in the art for a more efficient and convenient means for operator technicians or other operator users to troubleshoot, repair, or provide regular maintenance to operators without requiring technicians or users to carry additional instruments. It is to these ends that the present invention has been developed.

### BRIEF SUMMARY OF THE INVENTION

To minimize the limitations in the prior art, and to minimize other limitations that will be apparent upon reading and understanding the present specification, the present invention describes a movable barrier operator with a touchscreen interface, which presents complex diagnostic and status information for an operator in a simple, straightforward manner.

A movable barrier operator, in accordance with one embodiment of the present invention, comprises: a motor configured to move a barrier; a touch-screen display; a processor; a memory; and one or more programs stored in the memory and configured to be executed by the processor, the one or more programs including: instructions for detecting one or more signals from one or more sensors in communication with the processor; instructions for generating data from the one or more signals, the data pertaining to one or more parameters of a movable barrier system; instructions for displaying the data on the touch-screen display; instructions for detecting a user contact with the touch-screen display; instructions for determining a command in response to the user contact; and instructions for altering the one or more parameters of the movable barrier system based on the command in response to the user contact.

A movable barrier operator, in accordance with another embodiment of the present invention, comprises: a motor configured to move a barrier; one or more sensors for generating one or more signals pertaining to one or more parameters of a movable barrier system; a controller for receiving the one or more signals pertaining to one or more parameters from the one or more sensors and transmitting a data pertaining to the one or more parameters to a user via a graphical user interface; and a touch-enabled display for enabling the graphical user interface, the graphical user interface configured for: generating one or more data objects associated with the data pertaining to the one or more parameters, and displaying the one or more data objects via the touch-enabled display.

A touchscreen interface, in accordance with one embodiment of the present invention, comprises: a computer usable medium having a readable program code embodied in the computer usable medium, the readable program code adapted to be executed to implement a method for monitoring a movable barrier system, the method comprising: receiving data generated by a controller situated in a movable barrier operator, wherein the controller is connected to one or more sensors for generating one or more signals related to one or more parameters of the movable barrier system, and wherein the data generated by the controller pertains to the one or more parameters; generating one or more outputs associated with the data received from the controller; and displaying the one or more outputs on a touch-enabled display of the movable barrier operator.

It is an objective of the present invention, to enable service providers with a tool that will facilitate the efficient training of technicians for servicing operators in the field.

It is another objective of the present invention, to provide technicians servicing operators with a user interface to set, diagnose, and alter settings of operators without requiring traditional instruments used to monitor an operator's status or settings pertaining to associated parameters.

It is yet another objective of the present invention to provide a tool for performing diagnostic and maintenance functions via an easy to use graphical user interface that is located directly on the operator itself.

These and other advantages and features of the present invention are described herein with specificity so as to make the present invention understandable to one of ordinary skill in the art.

### BRIEF DESCRIPTION OF THE SEVERAL VIEWS OF THE DRAWINGS

Elements and embodiments in the figures have not necessarily been drawn to scale in order to enhance their clarity and improve understanding of the invention. Furthermore, elements that are known to be common and well understood to those in the industry are not depicted in order to provide a clear view of the various embodiments of the invention.

FIG. 1 illustrates a block diagram of a movable barrier operator in accordance with an exemplary embodiment of the present invention, wherein the movable barrier operator is connected to a movable barrier and comprises a display for providing a graphical user interface to set system parameters and perform system diagnostics.

FIG. 2(a) illustrates an exemplary user interface for configuring, altering, and monitoring system functions and parameters.

FIG. 2(b) illustrates an exemplary screen output of a user interface in accordance with one embodiment of the preset invention, which may be provided to a user upon selecting a setup option to configure components or set parameter values pertaining to a movable barrier system.

FIG. 2(c) illustrates an exemplary screen output of a user interface in accordance with one embodiment of the present invention, the screen output comprising a settings control panel, in accordance with an exemplary embodiment of the present invention.

FIG. 2(d) illustrates an exemplary screen output of a user interface in accordance with one embodiment of the present invention, the screen output comprising a timer control panel for setting a functioning time of one or more system components, in accordance with an exemplary embodiment of the present invention.

FIG. 2(e) illustrates an exemplary screen output of a user interface in accordance with one embodiment of the present invention, the screen output comprising an inputs and limits control panel for displaying the status of one or more devices of the movable barrier system, in accordance with an exemplary embodiment of the present invention.

FIG. 2(f) illustrates an exemplary screen output of a user interface in accordance with one embodiment of the present invention, the screen output comprising an event access panel for accessing one or more events recorded by the movable barrier system, in accordance with an exemplary embodiment of the present invention.

FIG. 2(g) illustrates an exemplary screen output of a user interface in accordance with one embodiment of the present invention, the screen output comprising a diagnostics control panel for providing several user-interface objects or graphical representations pertaining to one or more parameters of the movable barrier system, in accordance with an exemplary embodiment of the present invention.

FIG. 2(h) illustrates an exemplary screen output of a user interface in accordance with one embodiment of the present invention, the screen output comprising a communications information panel for revealing one or more devices connected to the movable barrier system, in accordance with an exemplary embodiment of the present invention.

FIG. 2(i) illustrates an exemplary screen output of a user interface in accordance with one embodiment of the present invention, the screen output comprising an advanced settings panel for providing additional control and monitoring capabilities to the user of the movable barrier system, in accordance with an exemplary embodiment of the present invention.

### DETAILED DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

In the following detailed description, a movable barrier operator may be any system that controls a barrier to an entry, an exit, or a view. The barrier could be a door for a small entity (i.e. a person), or a gate for a large entity (i.e. a vehicle), which may swing out, slide open, or roll upwards. The operator, which moves the barrier from an open position to a closed position and vice-versa, may be manual or automatic and may be controlled locally or remotely.

Generally, the present invention involves a movable barrier operator with a touchscreen user interface, or an operator with a touch-enabled display that provides a graphical user interface (GUI) to enable easy-to-use functions for installing, troubleshooting, or controlling a movable barrier operator. This display implemented with the barrier operator has the advantage of displaying meaningful information without the need to use pseudo-words to communicate a message, a setting or an option to the user. In the same manner, the GUI offers the capability to present readable and meaningful messages in case of errors or malfunctions instead of displaying error codes or pseudo-language that inadequately describes these errors.

There are several advantages to having such a user interface. For example, the user may be presented a graphical representation of settings or functions. Parameters such as battery voltages may be represented graphically with a battery icon and a percentage level, giving the user a clear indication of the battery capacity and current battery level, even without appreciable background knowledge or technical know-how on the part of the user. Similarly, a voltage can be represented graphically by a bar graph, line graph, or the like to provide a visual indication of voltage over time for purposes of troubleshooting.

The GUI adds value since icons, names, and buttons can be clearly displayed as well as representations for sensors, settings and parameters associated with one or more components of the operator and system. The user interface may make use of other known technology to facilitate its use, such as lighting sensors to detect ambient light and adapt to the environmental so as to ensure visibility of presented information at all times.

Other functionalities may also be implemented such as providing historical data and complete reports or records of previous services in a visual manner. The display adds value in customizing tech support windows with logos and contact information of the proper service technician, the contact information being, for example, a phone number or email address. The GUI may also clearly indicate or depict the errors and needs for service in a textual or graphical manner.

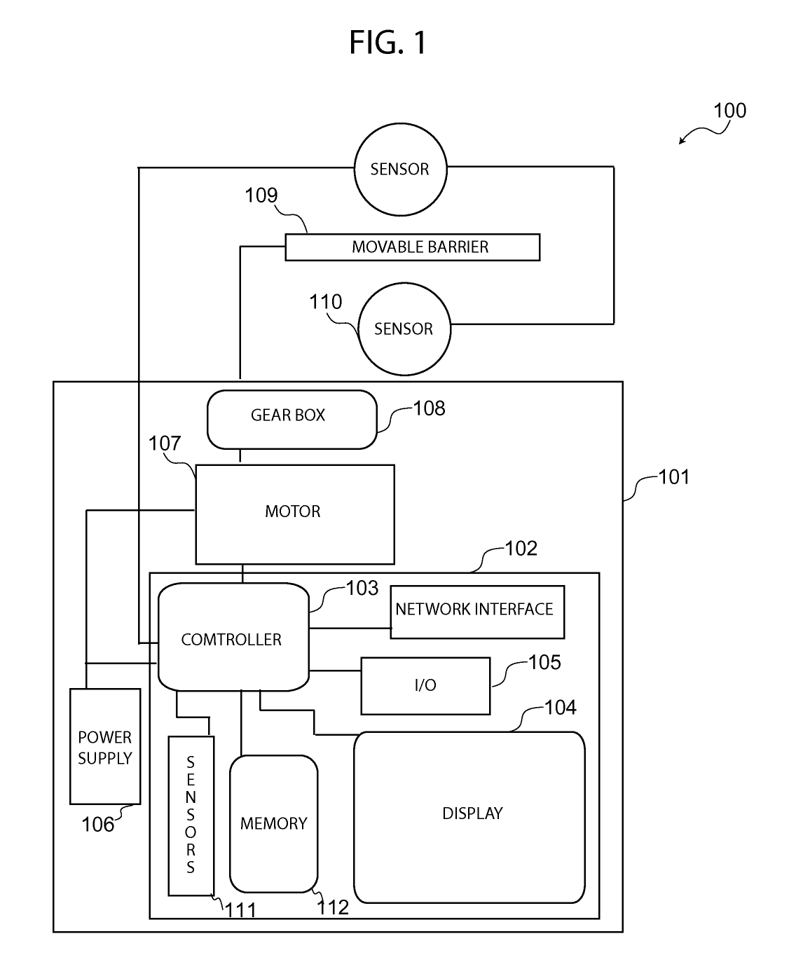

FIG. 1 illustrates a block diagram of a movable barrier operator in accordance with an exemplary embodiment of the present invention, wherein the movable barrier operator is connected to a movable barrier and comprises a display which provides a graphical user interface to set system parameters and perform system diagnostics. System 100 comprises operator 101, control box 102, controller 103, programmable memory 112, display 104, inputs/outputs (I/O 105), power supply 106, motor 107, gear box 108, movable barrier (barrier 109), external sensors 110, and internal sensors 111.

Operator 101 may include any machine or system that controls the movement of barrier 109. Operator 101 may move barrier 109 to its open position, its closed position, or to any intermediary position. Operator 101 may also start or stop movement of barrier 109 at any point along the movement track of barrier 109. In one embodiment, movable barrier 109 is a horizontally sliding gate, and operator 101 may control the horizontal sliding motion of barrier 109. In another exemplary embodiment, where movable barrier 109 is an upward swinging garage door, operator 101 may control the pivot swinging motion of movable barrier 109.

Operator 101 comprises control box 102, which houses controller 103, programmable memory 112, display 104, TO 105, and internal sensors 111. Typically, an outer shell or housing further encloses control box 102 and houses power supply 106, motor 107, and gear box 108. Alternatively, a single housing may encapsulate or house all of the components of operator 101 without requiring control box 102; however, control box 102 may be desirable to compartmentalize circuitry of operator 101 that control movement of barrier 109, influencing movement speed, delays, the ability to open and close, and so forth.

Controller 103 may comprise of one or more processors configured to access and process a set of instructions in a program code stored in programmable memory 112. The one or more processors of controller 103 may run or execute one or more software programs or set of instructions that may be stored in programmable memory 112, or stored in an internal memory of controller 103 (not shown), in order to perform the various functions of operator 101. For example, controller 103 may processes, relay, or carry out either pre-programmed or user-entered instructions or commands pertaining to operator 101 in order to change a parameter, enable or disable a function, or provide information about system 100 to a user of operator 101.

Programmable memory 112 may employ any number of well known configurations for creating a suitable memory to store one or more executable programs. Programmable memory 112 may comprise of one or more computer readable mediums, including a memory controller, which are accessed by the one or more processors of controller 103. Programmable memory 112 may include high-speed random access memory and may also include non-volatile memory, such as one or more magnetic disk storage devices, flash memory devices, or other non-volatile solid state memory devices. Access to programmable memory 112 by controller 103 may be accomplished by known means such as utilizing a memory controller.

Display 104 may be configured to display or enable a GUI, which greatly decreases the learning curve associated with programming, maintaining, updating, and understanding a movable barrier operator such as operator 101 by allowing for once-cryptic error signals and displays to be transformed into a user friendly system for the layman. Rather than using a miniscule display only capable of displaying brief messages or error symbols and being understood only by more technically knowledgeable users, the present invention provides an interactive display geared towards presenting systemic information in a manner that is meaningful and sufficiently descriptive of the problem or issue at hand. Furthermore, display 104 is typically a touch-screen display that implements virtual or soft buttons, or tabs, for a user to interact with.

Display 104 may thus be a touchscreen that provides an input interface and output interface between operator 101 and a user. Display 104 may comprise known-in-the-art components such as a display controller for communicating electrical signals between the touch screen and controller 103 (i.e. receiving and sending electrical signals for detecting a user's contact with the screen of display 104) and generating a visual output to the user. The visual output may include graphics, text, icons, video, and any combination thereof to provide an output screen that enables a user to monitor, configure, or alter the system's parameters. Furthermore, the screen output may comprise of virtual buttons such as tabs for enabling or disabling functions of system 100, or accessing component information for system 100 such as information pertaining to slave operators or wireless devices in communication with system 100.

Display 104 comprises a screen that may include a liquid crystal display or LCD, light emitting polymer display or LPD, or any other type of touchscreen display that may be configured to enable a GUI; furthermore, any type of known touchscreen hardware may be implemented without limiting the scope of the present invention. Display 104 may detect a user contact using any type of known touch sensing technologies. For example, and without limiting the scope of the present invention, display 104 may comprise touch-sensitive sensors for receiving input from the user based on tactile contact. Display 104 may utilize these sensors along with controller 103 to run or execute one or more programs stored in programmable memory 112, which contain a set of instructions for detecting a user's contact with display 104 and converting or generating a command based on the user interaction with the screen output, such as data objects or user-interface objects displayed on the screen output. Again, the screen output may include graphics, text, icons, video, and any combination thereof that enables a user to monitor, configure, or alter the system's parameters. The program or programs also include instructions to receive signals from system 100 components such as external sensors 110 and internal sensors 111. Thus, display 104 enables a user interface or GUI that allows a user to interact with system 100 via operator 101.

In one embodiment, the GUI comprises one or more programs that may include instructions for receiving one or more signals from one or more sensors in communication with controller 103 (such as sensors 110 or sensors 111); instructions for generating data from the one or more signals (i.e. graphics, text, icons, video, and any combination thereof that enables a user to monitor, configure, or alter the system's parameters), the data pertaining to one or more parameters of system 100; instructions for displaying the data on the touch-screen display (e.g. display 104); instructions for detecting a user contact with the touch-screen display; instructions for determining a command in response to the user contact; or instructions for altering the one or more parameters of system 100 based on the command in response to the user contact.

Instructions for displaying the data may include instructions to display a screen output. For example, and without limiting the scope of the present invention, the screen output may include: displaying a settings control panel for altering the value of the one or more parameters of system 100; displaying a timer control panel for setting a functioning time of one or more components of system 100; displaying an event access panel for accessing one or more events recorded by system 100; displaying a communications information panel for revealing one or more devices connected to system 100; and or displaying an inputs and limits control panel for displaying the status of one or more devices of system 100.

The GUI may be programmed or configured to do, without limitation, any of the following: generate one or more data objects associated with the data pertaining to one or more parameters of the system; display the one or more data objects via the touch-enabled display, wherein the one or more data objects comprise a graphical representation of the one or more parameters; receive a user input for altering a value pertaining to the one or more parameters; and generate a command signal for commanding the controller of the movable barrier operator to change the one or more parameters of the movable barrier system according to the user input.

For example, and without limitation, the parameters of system 100 may include: a motor current; a motor voltage; an AC voltage; a battery charge; a functioning time of one or more components of system 100; a hold open timer status; an obstruction sensor sensitivity level; an overlap timer status; a motor or barrier speed; a motor or barrier acceleration; a synchronization status; a self-secure status; an automatic barrier operation status; and any other programmable or pre-programmed parameter of system 100. Other parameters may further include environmental parameters of the system's GUI, for example and without limitation, environmental parameters may include contrasts, brightness, ambient lighting, and any other environmental parameters that will facilitate a users use of system 100's GUI.

The GUI, or touchscreen interface, may be one or more software or programs stored in programmable memory 112. These one or more programs, or readable program code, may be adapted to be executed to implement a method for monitoring system 100. The method may include, without limiting the scope of the present invention, receiving data generated by controller 103, wherein controller 103 is connected to one or more sensors for generating one or more signals related to one or more parameters of system 100. The method may further include the steps of generating one or more outputs associated with the data received from the controller, and displaying the one or more outputs on a touchscreen display of the movable barrier operator. Because the data generated by the controller pertains to the one or more parameters of the system, a user is given access to information about system 100 in a unique, easy-to-read format. Furthermore, the method may include the steps of receiving a user input for altering a value pertaining to the one or more parameters, and generating a command signal for commanding the controller of the movable barrier operator to change the one or more parameters of the movable barrier system according to the user input. In this way, a user may be provided with monitoring, configuring, and controlling capabilities over one or more components of the movable barrier system.

To illustrate the problems associated with previous iterations of operators, and to expound on the benefits of implementing operator 101 with a movable barrier system, consider the following: Occasionally, retuning and setting system parameters is accomplished mechanistically by altering system components directly. For instance, trimmer potentiometers (trimpots), momentary buttons, switches, and dual in-line package switches (DIP switches) are a few of the common means with which to calibrate, activate, deactivate, or customize an operator's settings and diagnostic tools. However, manipulating such mechanisms is remarkably unintuitive, as quite often it is difficult to decipher exactly what impact a particular mechanism will have on the complex operator system. In the past, it was sometimes necessary to directly manipulate the control box's controller and risk accidentally altering a crucial component of basic functionality for the operator. In any case, this method of retuning and setting system parameters presents a high learning curve for interaction with a movable barrier operator, and as such, necessitates both extensive and expensive training for technicians. Furthermore, such work is slow and cumbersome by comparison to the described movable barrier operator with a display-enabled graphical user interface.

The present invention addresses the abovementioned issues by providing a simple, visual means for influencing the controller of a movable barrier operator, for instance controller 103 of operator 101. Display 104 serves as an interface for an installer, technician, or general user for tasks ranging from installation to troubleshooting, diagnosing problems, and monitoring and commanding the operator primarily through controller 103.

In an exemplary embodiment, the touchscreen interface may facilitates any number of tasks such as, but not limited to, implementing or checking: power levels, battery capacity, radio receiver status, loop detection, gate timing, gate speed, travel limits, obstruction detection, gate movement status, power failure safeguards, system shutdown timing, GUI environmental settings such as display contrast or ambient light adjustment and detection, reading of incoming and outgoing voltages and current, offering service technician contact information, monitoring power supply functionality, and displaying past actions and tests undergone for a determined range or period of time.

I/O 105 is coupled to controller 103 and serves to connect directly to particular components of operator 101. For instance, a user may use I/O 105 to connect to system 100's radio station, loop connector, open commands, guard station, and master/slave relationships, among any number of other components and features that could be connected to through I/O 105. In an exemplary embodiment, IO 105 may be placed adjacent to display 104 so that a user can just as easily access internal components via IO 105 as display 104.

Power supply 106 may be the primary source of power for operator 101. In the present figure, power supply 106 is an internal component of operator 101 and may draw power through a power cable from a typical power source.

As previously mentioned, components of operator 101 coupled to controller 103 are capable of receiving commands via interaction with display 104. Thus, power supply 106 may receive commands from controller 103 through display 104. For example, display 104 may display an option which, when selected, communicates to controller 103 to force power supply 106 to limit the supply of power forwarded to operator 101 after 10 minutes of inactivity from movable barrier 109.

Additionally, information pertaining to power supply 106 may be retrieved from display 104. Without limiting or deviating from the spirit or scope of the present invention, information pertaining to power supply 106 presented on display 104 may be past and present incoming and outgoing AC voltage levels, surge protection indications, power levels, voltage transformer functionality, or any other information relevant to power supply 106.

Controller 103 sends signals to motor 107, which in turn actuates gear box 108 to move barrier 109. Often, this signal will be triggered by activation of either external sensors 110 (e.g. when a vehicle approaches barrier 109) or user input (e.g. a user sends a signal to actuate barrier 109).

Barrier 109 is typically mechanically connected to operator 101, for example via gear box 108, which enables movement of barrier 109 when the motor within operator 101 is actuated. Barrier 109 may be any type of barrier, as stated above, without limiting or deviating from the scope of the present invention. In an exemplary embodiment, barrier 109 is a gate to a structure that may be slid or swung open or closed. Though barrier 109 is not an internal component of operator 101, display 104 within operator 101 still displays a plethora of information pertaining to it. For example, display 104 presents dynamic settings and status information pertaining to barrier 109 such as, but not limited to, barrier movement speed, current position, open position, closed position, length of time to remain open, slow down speed, and so forth. Previously, much of this information was not easily ascertainable or alterable. Consequently, either significant time and money had to be spent training technical professionals to look at and or change these settings, or the operator owner was forced to rely on factory settings that often would not suit the needs of the barrier or the desires of said operator owner. Furthermore, such information about the barrier may be important for troubleshooting purposes—for example, easy visual verification of mechanical obstructions, or visual verification of system parameters will aid an owner or user to easily identify data that would otherwise require a much higher learning curve such as the skill and know-how of a trained technician.

External sensors 110 are typically electronically connected to operator 101 and provide a variety of information pertaining to the system. External sensors 110 may comprise of obstruction sensors, loop-induction sensors, or any other type of sensors adapted for generating a signal to either stop or actuate movement of barrier 109. For example, external sensors 110 may generate a signal which indicates to the system that a vehicle is approaching barrier 109 and that barrier 109 should remain open.

Other types of sensors related to operator 101 exist, such as internal sensors 111. Internal sensors 111 comprise of sensors pertaining to the operator's internal components, each of which may be coupled to system 100's controller 103. For example, and without limiting or deviating from the scope of the present invention, internal sensors 111 may include surge protection sensors, voltage sensors, current sensors, amperage sensors, or any other type of internal sensor that may provide status or diagnostic information pertaining to system 100. Utilizing several types of sensors throughout system 100 facilitates optimal functionality of the system and provides additional information to an operator user. This information may be displayed on display 104 in the form of surge protection indicators, voltage level graphs, current level graphs, amperage level graphs, and so forth.

Presenting information in a descriptive, visual, and succinct manner such as that done through a GUI displayed on display 104 is advantageous for a number of reasons, but consider the following scenario as an illustration of just one advantage: If a gate guard notices the gate he or she mans is no longer opening properly, said gate guard may then simply investigate historical data logs of the operator controlling his or her manned gate via display 104 to discover which logged error or errors match the timeframe of the gate's malfunction. If display 104 displays an error sent by a surge protection sensor consistent with the gate's malfunction, the gate guard may then inform an operator technician of the likely problem at hand, giving the technician an idea of which tools may be necessary for the repair.

Other components not shown in FIG. 1 but that may nonetheless make up operator 101 may include movable barrier subsystems such as slave operators controlled by operator 101. Such slave operators may control access to a location by being mechanically coupled to additional movable barriers. For example, in one embodiment, operator 101 is a master operator and is configured to control at least one other barrier which is coupled to yet another barrier, for example tandem gates on the same property. Thus, a technician with access to operator 101 may glean diagnostic data and even set controls and parameters for the slave operator which is in communication with operator 101.

In practice, operator 101 may often have a cover or housing covering the components just enumerated. But in such times as a technician or other user needs to access operator 101, the housing may be temporarily removed. In the present embodiment, removal of the housing would yield access to display 104 as well as most of the internal components of operator 101. However, in a separate exemplary embodiment, display 104 resides within an outer housing, but outside of a separate inner housing which protects many of the other internal components of operator 101 such as motor 107 and gear box 108. Thus, removal of the outermost housing may yield access to display 104 for convenient diagnostic use without having to expose many of the remaining components of operator 101.

In one embodiment, control box 102 houses display 104 and a controller 103, and programmable memory 112. Traditionally, a control box might comprise a multitude of physical buttons with a few cryptic letters, numbers, or symbols describing what effect the button has on the system. Often, such letters, numbers, and symbols are entirely omitted, leaving a user with little information to guide a decision relating to calibrating, maintaining, or diagnosing the system. Unsurprisingly then, training a technician to sufficiently understand each setting to command the controller, as well as any other setting or feature present in the remaining components of an operator, is necessarily cumbersome, time consuming, and expensive. By substituting confusing physical buttons with descriptive, understandable information on a display, each of these problems is greatly mitigated.

In another exemplary embodiment, display 104 has a display size roughly equivalent to that of most tablet-type displays so that icons, descriptions, explanations, parameters, and any other type of options are clearly visible and easy to interact with. Without deviating from the spirit or scope of the present invention, display 104 may be larger or smaller than a tablet-sized display. Display 104 provides the GUI to present information in a clear and structured manner, without the need to enter command lines comprising complex code.

In an exemplary embodiment, information displayed via the graphical user interface may be classified by whether the information is part of installation and or setup or part of maintenance and or diagnostics. Already, such a classification filters out many unwanted options that would otherwise remain in traditional operators and possibly confuse the installer, technician, or general user. Sub-classifications within these classifications further aid in isolating and identifying the desired setting, parameter, diagnostic tool, reading, or option to be selected or viewed, while simultaneously clearing away extraneous or acutely irrelevant options.

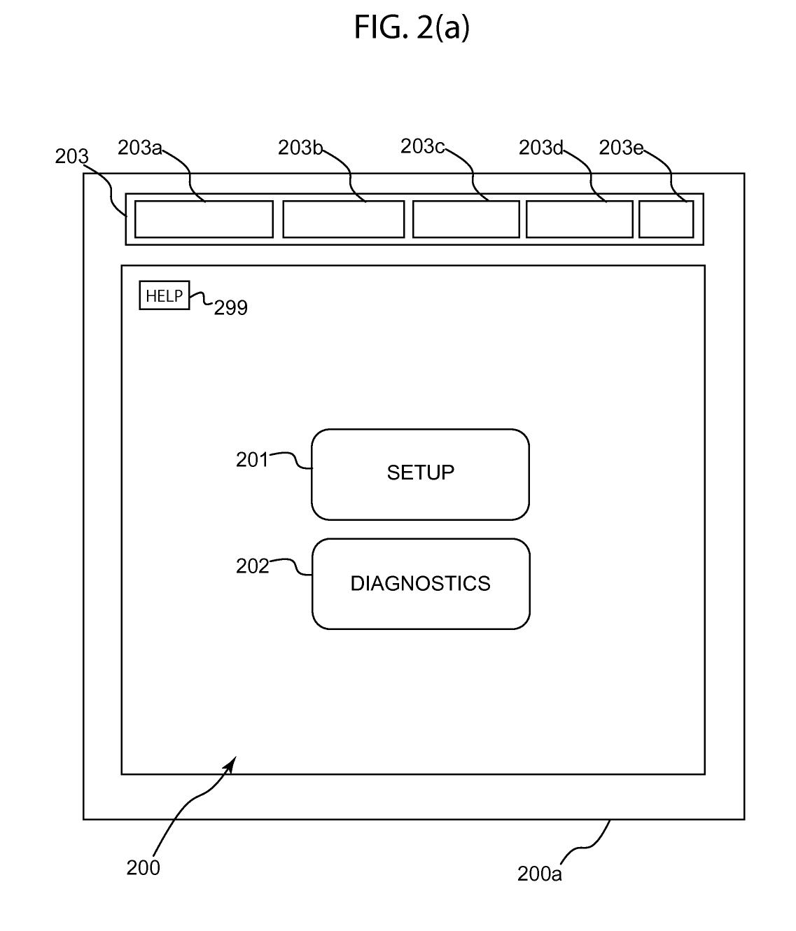

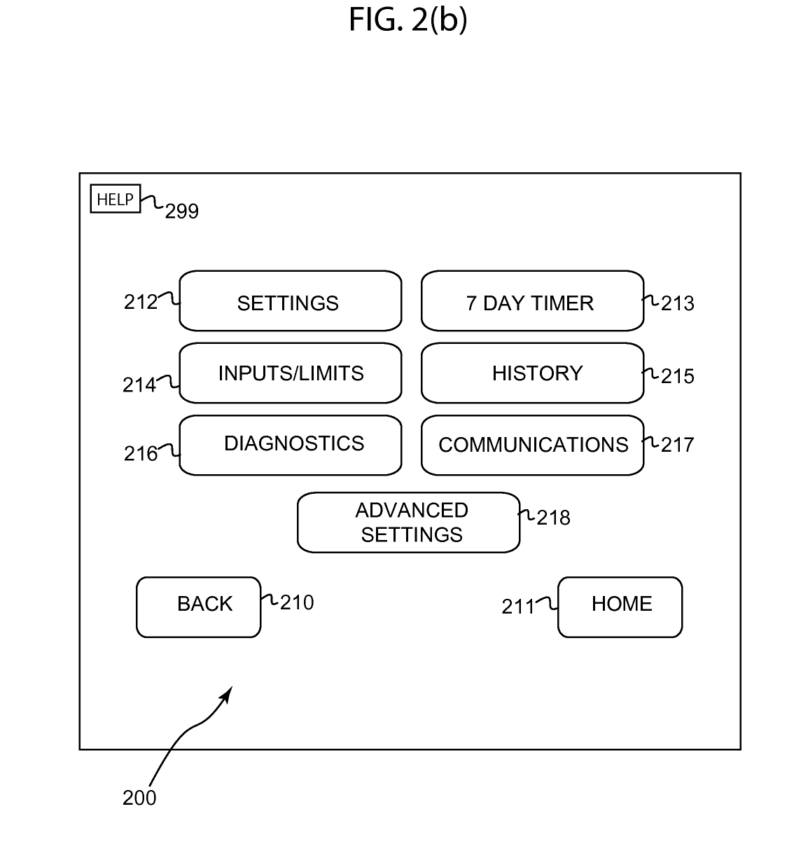

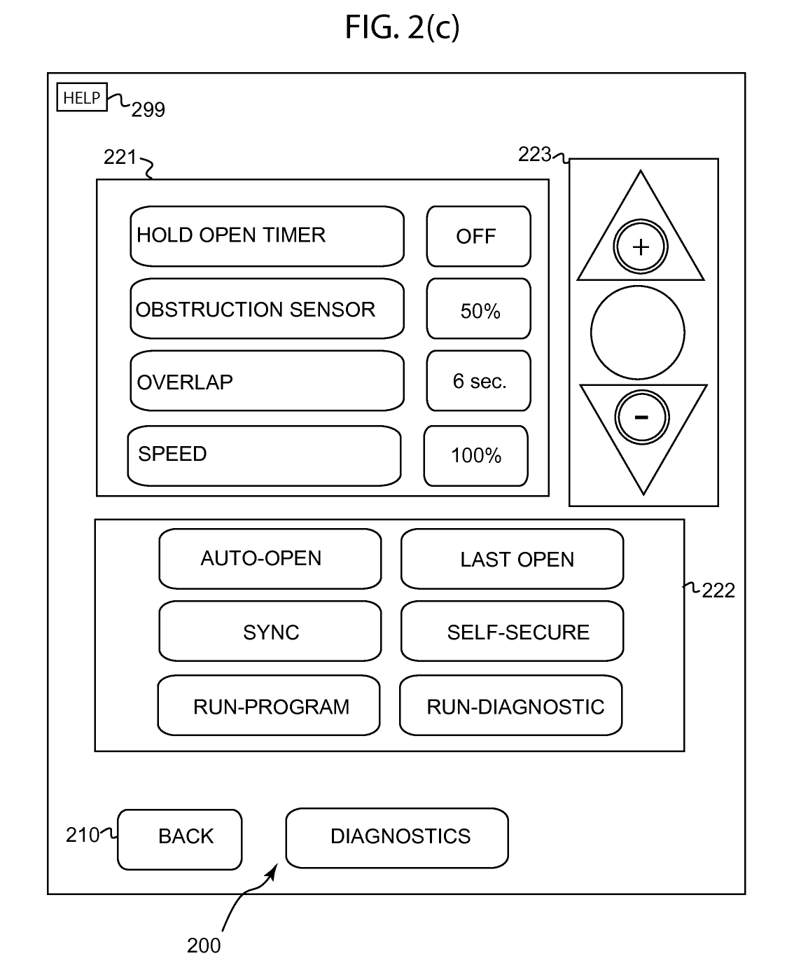

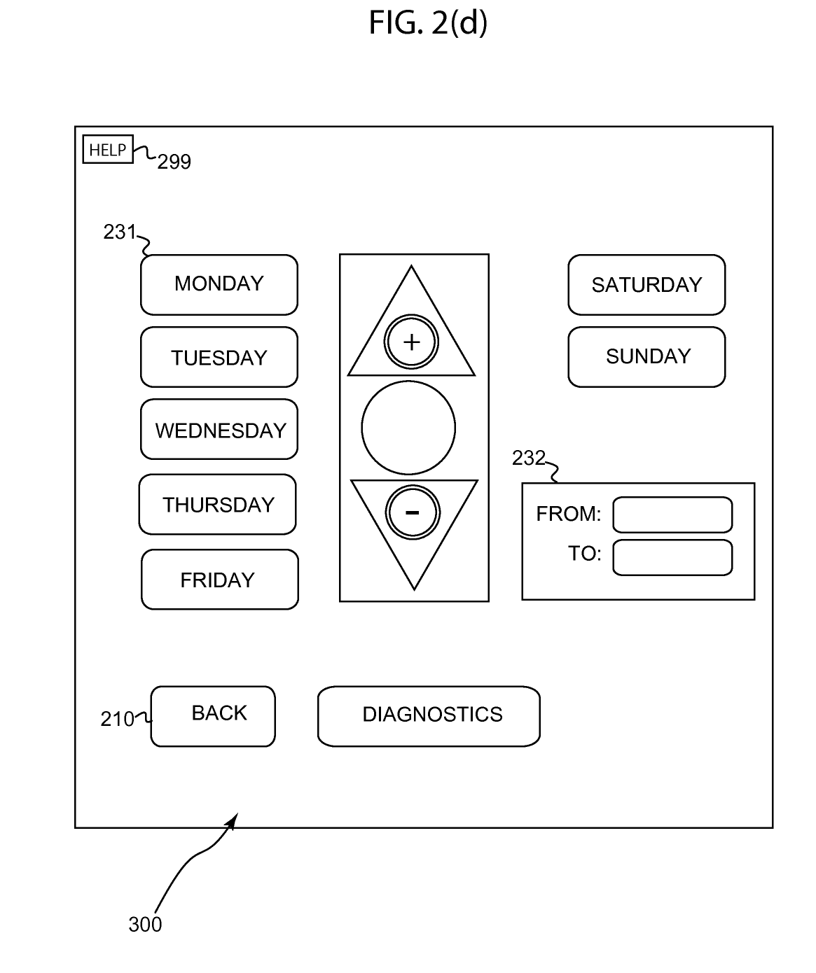

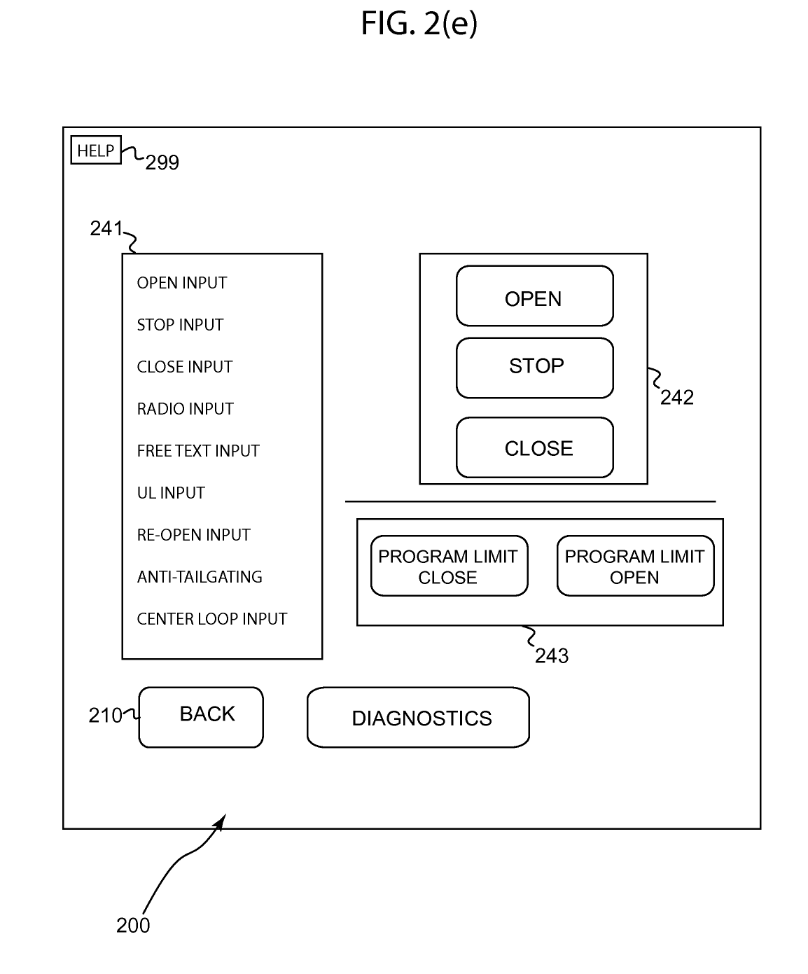

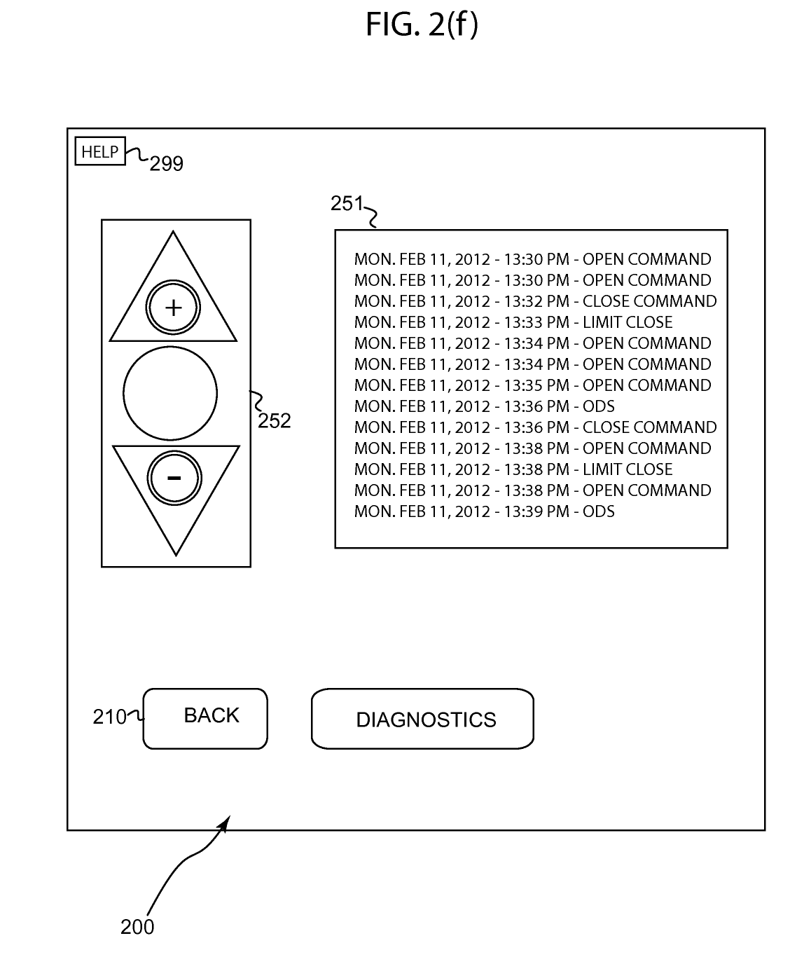

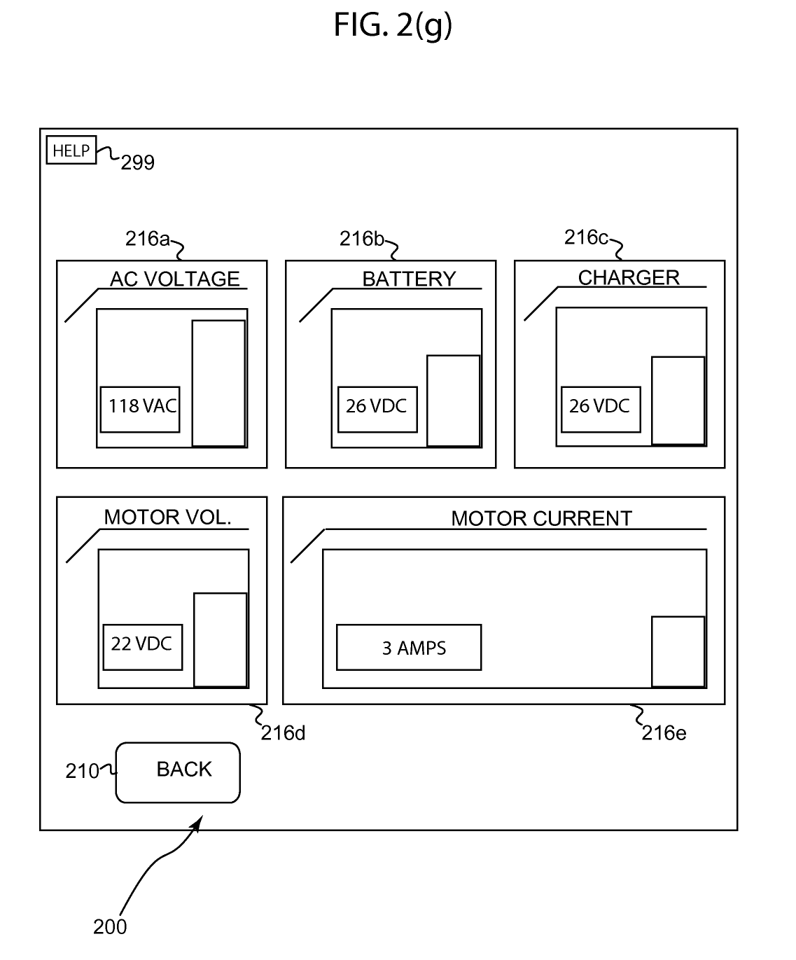

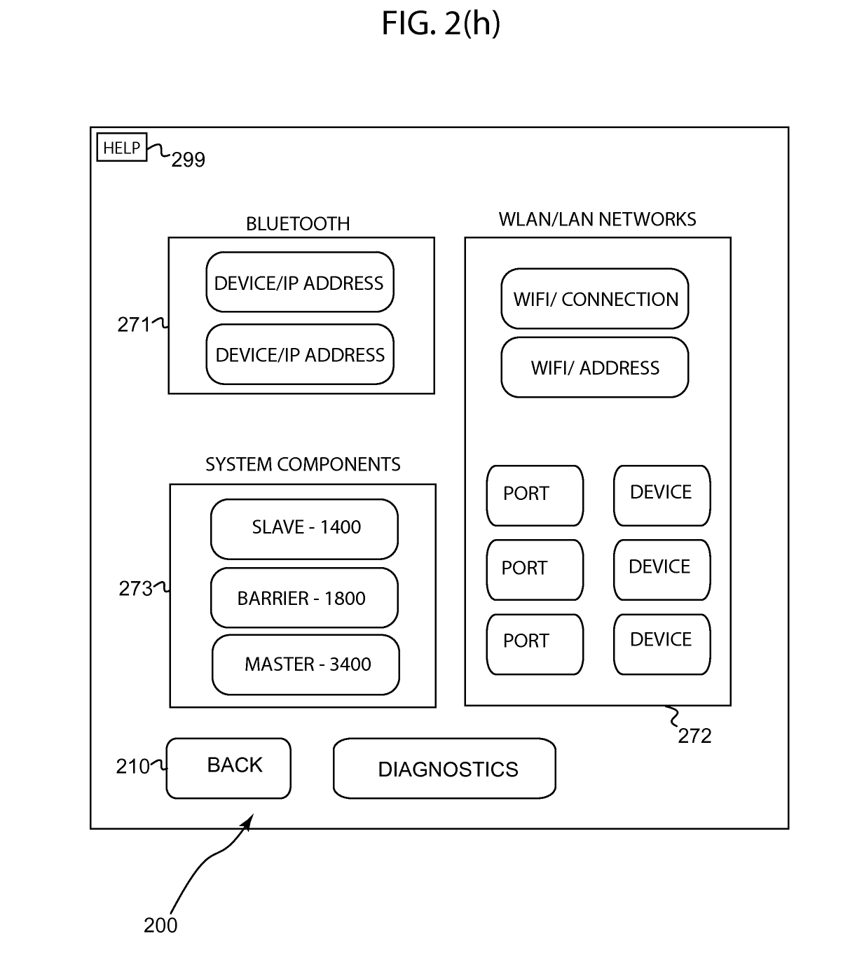

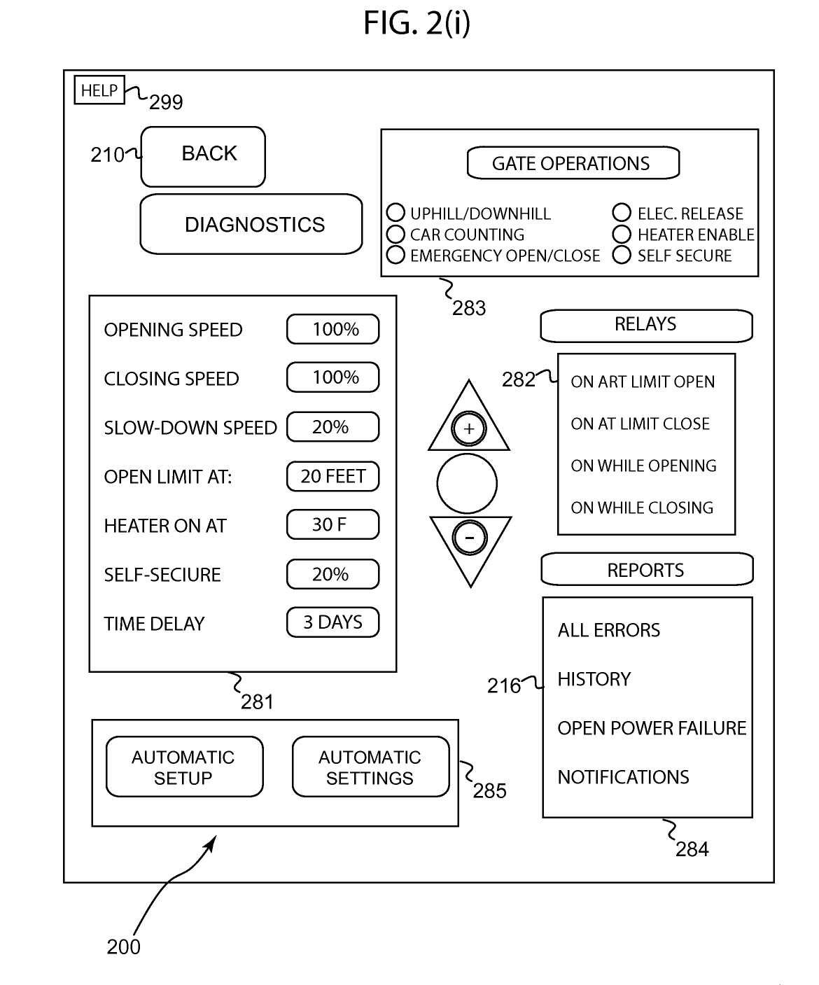

FIGS. 2(a)-2(i) depict visual representations of screen outputs that may be provided to a user via a GUI in accordance with exemplary embodiments of the present invention. Each of the following figures exemplarily describes a touchscreen interface. The user need only press or touch the desired tab or option on the display to make a selection. Without limiting the scope of the present invention, a display may instead employ a GUI that does not require touch or gestures to enable function, but implement one or more physical navigating buttons or keys.

In the discussion of FIGS. 2(a)-2(i), a user may refer to an installer, technician, or any other person interacting with the operator. Additionally, discussion of tabs may also refer to the content that would be presented to a user once the respective tab is selected.

FIG. 2(a) illustrates an exemplary user interface for configuring, altering, and monitoring system functions and parameters; FIG. 2(a) depicts a visual representation of the basic-most screen a user might encounter on the display, in accordance with an exemplary embodiment of the present invention. With respect to the illustrated figure, display 200a comprises a screen for providing GUI 200. In exemplary embodiments, such as the one depicted, display 200a may further comprise I/O 203 for providing access to operator components. I/O 203 may include radio connector 203a, loop connector 203b, open commands connector 203c, guard station connector 203d, and master slave connector 203e.

I/O 203 serves as a convenient means for a user to manipulate, diagnose, or otherwise interact with a particular component within the operator. For instance, a user wishing to interact with the system's master and slave relationship may simply form an appropriate connection with the master and slave input. I/O 203, thus, serves as a supplement to the described display-enabled graphical user interface.

With respect to the illustrated exemplary embodiment, I/O 203 is adjacent to, specifically above, display 200a, providing nearby supplementary support for many of the tasks executable through interaction with display 200a. In other embodiments, I/O 203 is not adjacent to display 200a and may instead be located in any other suitable location that would be known by a person of ordinary skill in the art.

GUI 200 typically provides an initial screen for enabling initial setup as well as providing access to the various functions available. For such an initial screen, GUI 200 may provide setup tab 201, and diagnostics tab 202. Furthermore, GUI 200 may also provide assistance tab 299, which may be implemented throughout the displayed screens provided by GUI 200.

Setup tab 201 may be the option a user may select to begin system installations and updates, set inputs or parameters, review past data and results, contact a technician, view general and specific system settings, program diagnostic display parameters, and so forth. Diagnostics tab 202 may be the option a user may select to view diagnostic information such as but not limited to, AC voltage, DC voltage, battery voltage, motor current and amperage, or solar charger status. To select a tab or option on this display, the user need only press the tab or option within its confines. While such an embodiment implements a touch-screen or touch enabled gestures for functionality, other embodiments may merely provide a regular display that includes minimal input buttons for navigating and interfacing with GUI 200.

For example, and without limiting the scope of the present invention, setup tab 201 may provide a user with a vast choice of preferences or settings pertaining to the GUI environment. To these ends, setup tab 201 may enable changing display contrast; changing display brightness, selecting a system language; activation or deactivation of audible read-out of the displayed information; and providing step-by-step installation procedures of the operator. In one embodiment, setup tab 201 provides step-by-step installation procedures as well as an option to provide instructions based on a query provided to the user. For example, and without deviating from the scope of the present invention, upon selecting setup tab 201, a user may thereafter be provided with a set of questions or requests for input pertaining to system preferences, user preferences, system configurations or other pertinent information. Upon receipt of the user input in response to the query, the system may be automatically configured or setup using the selected or provided answers to the query. This allows for easy to use instructions that enable any user with minimal skill to setup and operate the operator.

To expand on the latter example, the GUI may further provide installation procedures or installation options and instructions for auxiliary components, devices, or accessories, such as new sensors or any other components that may later be added to the movable barrier system. Thus, setup tab 201 may be, in some embodiments, a hub for information on setting up the system as well as system components and system preferences.

Setup and diagnostic tabs 201, 202, may provide an abundance of easily locatable and understandable commands and options that would otherwise be lost in the archaic and often overwhelming presence of cryptic buttons on the operator. Additionally, without the assistance of a sizeable display, a user of a traditional operator pressing the correct button to enact a desired change might not receive adequate feedback to be more than moderately certain that change was actually enacted. The present invention alleviates this concern.

Assistance tab 299 may provide access to a user guide or answers to commonly asked questions, or provide searchable functions for the user to find information about how to utilize the system. As is illustrated for purposes of showing examples and in no way limiting the invention, assistance tab 299 may be displayed in all or some of the screens provided by GUI 200. A simple “Help” text or icon may be displayed to let a user know that assistance tab 299 may provide a resource of information to the user.

FIG. 2(b) illustrates an exemplary screen output of a user interface in accordance with one embodiment of the preset invention, which may be provided to a user upon selecting a setup option to configure components or set parameter values pertaining to a movable barrier system; FIG. 2(b) depicts a visual representation of a series of tabs that may be presented to a user upon selecting setup tab 201 shown in FIG. 2(a), in accordance with an exemplary embodiment of the present invention. Without limiting the scope of the present invention, GUI 200 may provide back tab 210, home tab 211, basic settings tab 212, timer tab 213, inputs tab 214, history tab 215, diagnostics tab 216, communications tab 217, and advanced settings tab 218.

Back tab 210 returns the user to the previously reviewed screen. Home tab 211 returns the user to the basic-most screen, for example a screen such as the screen displayed in FIG. 2 (a). Basic settings tab 212 comprises a compilation of basic commands a user might want to alter, such as the movement speed of the barrier. Timer tab 213 comprises a simple means to program a desired time for a barrier to close or open either briefly or for an extended period. Inputs tab 214 comprises a series of inputs, limits and other operating parameters that impact the functionality of the barrier. History tab 215 comprises a log of information pertaining to past behaviors and diagnostics run on the operator and the barrier. Diagnostics tab 216 comprises a number of graphical representations of system input, output, and general system functionality, particularly pertaining to the system's electrical components. Alternatively, diagnostics tab 216 may simply allow a user to set the display parameters for the diagnostic information presented with diagnostics tab 202. Communications tab 217 comprises network information, as well as information pertaining to devices communicating with the operator system. Advanced settings tab 218 comprises a myriad of settings more specific, pointed, and sometimes though not always less related to basic, overt functionality of the operator and barrier, such as the option for the operator to count cars passing through the barrier.

In accordance with an exemplary embodiment of the present invention, each of the following figures depicts a set of features that may be present within the tabs discussed in FIG. 2(b). Such features become accessible upon the user selecting the appropriate tab on the screen.

FIG. 2(c) illustrates an exemplary screen output of a user interface in accordance with one embodiment of the present invention, the screen output comprising a settings control panel, in accordance with an exemplary embodiment of the present invention; FIG. 2(c) depicts a set of options that may be present within basic settings tab 212, in accordance with an exemplary embodiment of the present invention.

In the present embodiment, GUI 200 provides a user with the option of manipulating core settings associated with the barrier. For example, and without limiting the scope of the present invention, selecting basic settings tab 212 may provide basic functions 221 and automatic functions 222.

Basic functions 221 may comprise a series of settings for controlling movable barrier behavior. These settings may include, but are not limited to, a hold open timer for setting the delay between when an open gate begins to close, an obstruction sensor sensitivity value, an overlap setting for tandem barriers, and a speed setting.

Automatic functions 222 may provide a series of options, the selection of which mandates behavior in certain circumstances, such as a power failure. For example, and without limiting or deviating from the scope of the present invention, automatic functions 222 may comprise of system mandates to automatically open a barrier, keep a barrier open, or keep a barrier locked and closed in the event of a particular event such as power failure. Other functions such as synchronizing an operator system to a barrier for automatic action may be provided as well. Additionally, programs for automatically running one or more functions of the movable barrier system may be pre-installed, so that users need only activate or deactivate in order to run these pre-installed routines. In one embodiment, pre-installed programs may include self-diagnostic routines that enable the operator to execute a set of tests and provide feedback or a report to the user pertaining to the status of one or more components of the movable barrier system.

Mandating action during power failures is a highly specific action, and as such, normally requires an experienced technician to know how to program an operator for such circumstances. By displaying an interface with such programming already complete and presented as a visually representative shortcut, a basic user or technician can quickly and easily address these more obscure issues.

Changing system parameter values or function settings, such as obstruction sensor sensitivity, overlap times, speed, and other functions such as automated functions, may be facilitated via GUI 200 by providing touch-enabled buttons to receive user input. In the exemplary embodiment shown, input controls 223 provide a means for users to input a desired parameter value, activate or deactivate a function, or toggle through provided information to select a particular setting.

FIG. 2(d) illustrates an exemplary screen output of a user interface in accordance with one embodiment of the present invention, the screen output comprising a timer control panel for setting a functioning time of one or more system components, in accordance with an exemplary embodiment of the present invention; FIG. 2(d) depicts a set of options that may be provided when a user selects timer tab 213, in accordance with an exemplary embodiment of the present invention.

For example, and without limiting the scope of the present invention, a user may be provided the option to set hours of operation display 232 for a given barrier, so that outside the set hours the barrier remains closed. Similarly, within the set hours the barrier remains either open or able to be opened by approaching the sensors. In an exemplary embodiment, hours of operation display 232 may be the same or different for each day of the week, wherein, for example, a user is able to keep the barrier open from 9 in the morning until 5 at night on weekdays, and keep the barrier closed altogether on weekends. This may be desirable for a place of business which requires an employee or visitor to pass through a gate to enter its premises. Days 231 displays each day of the week, so that when a day is selected from within days 231, hours of operation display 232 is adjusted to show the hours of operation for the selected day.

An interface with highly practical and simple options such as that found in the present embodiment of GUI 200 allows for easy setting of programmatically complex commands, greatly increasing the flexibility, functionality, and usefulness of operators and the barriers they control.

FIG. 2(e) illustrates an exemplary screen output of a user interface in accordance with one embodiment of the present invention, the screen output comprising an inputs and limits control panel for displaying the status of one or more devices of the movable barrier system, in accordance with an exemplary embodiment of the present invention; FIG. 2(e) depicts a set of options that may be provided when a user selects inputs tab 214, in accordance with an exemplary embodiment of the present invention. For example, GUI 200 may provide inputs 241, gate status 242, and limit programming 243.

Inputs 241 include but are not limited to functions which indicate devices capable of opening, closing, or stopping a barrier, signals received by the radio receiver, exit, reopen and center loop detection, secondary safety or entrapment protections, and anti-tailgating measures.

Barrier status 342 indicates the current status of a movable barrier, indicating whether the barrier is presently opening, closing, or stopped.

Limit programming 243 provides the means to program the limits of a movable barrier. For one example, the movable barrier may be programmed to move to a particular position before being considered open or closed. Limit programming 243 may also indicate to a user or technician when a new limit needs to be set.

FIG. 2(f) illustrates an exemplary screen output of a user interface in accordance with one embodiment of the present invention, the screen output comprising an event access panel for accessing one or more events recorded by the movable barrier system, in accordance with an exemplary embodiment of the present invention; FIG. 2(f) depicts a set of options that may be provided when a user selects history tab 215, in accordance with an exemplary embodiment of the present invention. For example, GUI 200 may provide data log 251, along with an input control feature such as input control 252.

Data log 251 provides a time-stamped log of events that have been recorded for the purposes of diagnosing or troubleshooting problems with the operator or movable barrier. For instance if a problem arises, a user or technician might be able to quickly ascertain what that problem is by looking at data log 251. Data log 251 may indicate when an input or limit was entered, altered, or activated, when a power failure or other malfunction or error occurred, when an obstruction was detected, or when temperature-related changes occurred, among a myriad of other historical data that could be presented to a user or technician.

FIG. 2(g) illustrates an exemplary screen output of a user interface in accordance with one embodiment of the present invention, the screen output comprising a diagnostics control panel for providing several user-interface objects or graphical representations pertaining to one or more parameters of the movable barrier system, in accordance with an exemplary embodiment of the present invention; FIG. 2(g) depicts a set of user-interface objects that may be provided when a user selects diagnostics tab 216, in accordance with an exemplary embodiment of the present invention.

For example, GUI 200 may provide information that could assist in system diagnosis and maintenance. GUI 200 may provide the operator's alternating current (AC) voltage via a user-interface object such as data object 216a. In the same diagnostic control panel screen, GUI 200 may provide the operator's battery voltage by providing an output including data object 216b, motor amperage may be displayed by data object 216d, a charger voltage may be displayed by data object 216c, a motor voltage may be displayed by data object 216d, and a motor current may be displayed by data object 216e. Other such information may be presented via a screen output by selecting a feature such as diagnostics tab 216 without deviating from the scope of the present invention.

For instance, GUI 200 may also provide direct current (DC) voltage or solar charge information. This information may exemplarily be depicted in graphical form, and may be designed to not only show current voltage, amperage, and battery levels, but also recent system values. Thus, an undesirable reading presented by a diagnostic display panel may be contextualized and better associated with the circumstances or events that caused the undesirable reading. For instance, if a gate opens slower than it is programmed to for an extended period of time, a user may select diagnostics tab 216 to find graphical displays of motor functionality. This display may show that a low motor voltage fits the timeline of slowed gate movement, which notifies the user of the likely cause.

In one embodiment, when viewing content within diagnostics tab 216, GUI 200 may instead only or additionally provide options for customizing the presentation of diagnostic information that would be seen within diagnostics tab 202 of FIG. 2(a). Thus, a user or technician would be able to decide which parameters could be presented on a particular screen of GUI 200 when choosing diagnostics tab 202 instead of input tab 201 on the main screen. To illustrate, a user may wish to closely monitor the operator's motor functions, but have no interest in viewing AC or DC voltage levels. This user may resultantly select options as to which diagnostic parameters will be displayed by GUI 200 when on the appropriate screen.

In any case, presenting voltage, amperage, battery levels, and the like via simple visual indicators not only makes the relevant information easier for the layman to understand, but also creates the circumstance by which a technician is no longer required to bring additional measurement apparatus such as voltmeters, amp-meters, or ohmmeters. Instead, this information is automatically tested and visually or textually reported back to the user.

FIG. 2(h) illustrates an exemplary screen output of a user interface in accordance with one embodiment of the present invention, the screen output comprising a communications information panel for revealing one or more devices connected to the movable barrier system, in accordance with an exemplary embodiment of the present invention; FIG. 2(h) depicts an array of communicative information that may be present within communications tab 217, in accordance with an exemplary embodiment of the present invention. With respect to the illustrated figure, display 200 comprises Bluetooth® connection 271, Wi-Fi™ connection 272, and system components 273.

Bluetooth connection 271 allows for wireless communication between local devices. Bluetooth connection 271 displays the system's router IP address, model number, and identification.

Wi-Fi connection 272 allows for wireless communication between various types of devices and the operator. For instance, the operator may be manipulated by a portable computer or a smart phone synced or configured to communicate with said operator.

Such access information may comprise port numbers or ranges and a corresponding device identifier to display which third party devices are configured to communicate with the operator, among other access information. These devices may further enhance a user's control over the setup, settings, limits, parameters, and diagnoses of the operator and serve as complementary devices for the display-enabled graphical user interface integrated into the operator's control box.

System components 273 offers information regarding connections of a movable barrier to a separate slave and or master apparatus, for instance an operator. Such master, slave, and barrier relationships would be known and understood by a person of ordinary skill in the art.

FIG. 2(i) illustrates an exemplary screen output of a user interface in accordance with one embodiment of the present invention, the screen output comprising an advanced settings panel for providing additional control and monitoring capabilities to the user of the movable barrier system, in accordance with an exemplary embodiment of the present invention; FIG. 2(i) depicts the myriad of additional settings within advanced settings tab 218 a user can utilize to further customize behavior of an operator and the barrier it controls, in accordance with an exemplary embodiment of the present invention. With respect to the illustrated figure, display 200 comprises settings quantifiers 281, relay 282, barrier operations 283, reports 284, and automatic settings 285.

Settings quantifiers 281 refers to the set of advanced settings employing percentages, distances, temperatures, lengths of time and so forth, as opposed to simple on and off toggle options. Settings quantifiers 281 includes such settings as barrier opening and closing speed, slow down speed, partial open position, heater initiation temperature, self-secure sensitivity, and length of time between performance reports, though this list is by no means exhaustive. Rather, this list is merely illustrative of the types of complex commands that might have previously required a highly trained technical professional to initiate or change.

Similarly, relay 282 comprises a number of tasks that can be easily set or altered through the display-enabled GUI. Relay 282 controls when a barrier's relay mechanism is active, such as at the time of a barrier's opening or closing, during times when the barrier is fully open or closed, or in case of emergencies. Depending on the user's preferences, these settings can be easily toggled on or off.

Barrier operations 283 describes another series of tasks that may be accomplished by the illustrated display-enabled GUI. For instance, the user may toggle options to specify behavior protocols depending on whether the gate is on an upslope or downslope, count the number of cars passing through a given barrier, mandate an emergency open or close for purposes such as system diagnosis, and perform multiple gate operations for remote diagnosis or control, and so forth.

Reports 284 allows a user or technician to select the types of system performance reports that should be provided. Combined with the option in settings quantifiers 281 allowing for customization of report frequency, system diagnostics may be extremely thorough, potentially saving a great deal of time and money on expensive or unnecessary system repairs.

Specifically, reports 284 allows a user or technician to specify whether reports should be generated after any system error, only critical errors, only as mandated by the report frequency option in settings quantifiers 281, upon any power failure, or any other similar circumstance that would be understood by a person of ordinary skill in the art.

Lastly, with respect to FIG. 2(i), automatic settings 285 provide a user or technician control over the broad functionality of the operator. For example, automatic settings 285 comprises options that allow for enablement or disablement of advanced system set-up mechanisms and options. Also, automatic settings 285 may, for instance, allow the system to automatically scan for problems or malfunctions and then self-configure a functional agenda based on these problems or based on input picked up from the system or the immediate environment. Thus, while the present display-enabled GUI provides a simple means of wholly customizing and maintaining an operator-movable barrier system, the system also allows for a degree of self-regulation if the user is not inclined to take advantage of system customization.

To summate, though initial setup, diagnosis, and maintenance of movable barrier systems can be an involved process only meant for highly trained technical professionals, the described display-enabled GUI transforms this process into one that can be handled with little training. Programmatically complex commands are presented as simple representative terms and graphics of options or tabs that better describe the desired actions to be undertaken by the movable barrier operator system.

A movable barrier operator with a touchscreen interface has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

What is claimed is:

1. A movable barrier operator, comprising:
a motor configured to move a barrier;
a touch-screen display;
a processor;
a memory; and
one or more programs stored in the memory and configured to be executed by the processor, the one or more programs including:
instructions for detecting one or more signals from one or more sensors in communication with the processor;
instructions for generating data from the one or more signals, the data pertaining to one or more parameters of a movable barrier system;
instructions for displaying the data on the touch-screen display;
instructions for detecting a user contact with the touch-screen display;
instructions for determining a command in response to the user contact; and
instructions for altering the one or more parameters of the movable barrier system based on the command in response to the user contact.

2. The movable barrier operator of claim 1, wherein instructions for displaying the data include instructions for displaying a settings control panel for altering the value of the one or more parameters of the movable barrier system.

3. The movable barrier operator of claim 1, wherein instructions for displaying the data include instructions for displaying a timer control panel for setting a functioning time of one or more components of the movable barrier system.

4. The movable barrier operator of claim 1, wherein instructions for displaying the data include instructions for displaying an event access panel for accessing one or more events recorded by the movable barrier system.

5. The movable barrier operator of claim 1, wherein instructions for displaying the data include instructions for displaying a communications information panel for revealing one or more devices connected to the movable barrier system.

6. The movable barrier operator of claim 1, wherein instructions for displaying the data include instructions for displaying an input and limit control panel for displaying the status of one or more components of the movable barrier system.

7. The movable barrier operator of claim 1, wherein instructions for displaying the data include instructions for displaying a parameter panel including numerical or graphical representations pertaining to the one or more parameters of the movable barrier system.

8. The movable barrier operator of claim 1, wherein instructions for displaying the data include instructions for displaying a step-by-step installation procedure of the system.

9. The movable barrier operator of claim 1, further comprising instructions for providing audible read-out of the information displayed on the touch-screen display.

10. The movable barrier operator of claim 1, further comprising instructions for displaying information in multiple languages.

11. The movable barrier operator of claim 1, further comprising instructions for displaying assistance information to users of the movable barrier system.

12. The movable barrier operator of claim 1, wherein altering the one or more parameters comprises of altering:
a barrier speed;
a barrier acceleration;
a battery charge;
a hold open timer status;
an obstruction sensor sensitivity level;
an overlap timer status;
a synchronization status;
a self-secure status; or
any other programmable or a pre-programmed parameter of the movable barrier system.

13. The movable barrier operator of claim 1, further comprising instructions for running a self-diagnostic test.

14. A movable barrier operator, comprising:
a motor configured to move a barrier;
one or more sensors for generating one or more signals pertaining to one or more parameters of a movable barrier system;
a controller for receiving the one or more signals pertaining to one or more parameters from the one or more sensors and transmitting data pertaining to the one or more parameters to a user via a graphical user interface; and
a touch-enabled display for enabling the graphical user interface, the graphical user interface configured for:
generating one or more data objects associated with the data pertaining to the one or more parameters, and
displaying the one or more data objects via the touch-enabled display.

15. The movable barrier operator of claim 16, wherein the graphical user interface is further configured for:
receiving a user input for altering a value pertaining to the one or more parameters; and
generating a command signal for commanding the controller of the movable barrier operator to change the one or more parameters of the movable barrier system according to the user input.

16. The movable barrier operator of claim 17, wherein displaying the one or more data objects comprise of displaying a graphical representation of the one or more parameters.

17. The movable barrier operator of claim 17, wherein displaying the one or more data objects comprise of displaying a timer control panel for setting a functioning time of one or more components of the movable barrier system.

18. The movable barrier operator of claim 17, wherein displaying the one or more data objects comprise of displaying a settings control panel that enables altering the value of the one or more parameters of the movable barrier system.

19. The movable barrier operator of claim 17, wherein displaying the one or more data objects comprises of displaying a history access panel for accessing one or more events recorded by the movable barrier system.

20. The movable barrier operator of claim 17, wherein displaying the one or more data objects comprises of displaying a communications information panel for displaying one or more devices connected to the movable barrier operator.

21. The movable barrier operator of claim 17, wherein displaying the one or more data objects comprises of displaying an inputs and limits control panel for displaying the status of one or more devices of the movable barrier system.

22. A touchscreen interface, comprising a computer usable medium having a readable program code embodied in the computer usable medium, the readable program code adapted to be executed to implement a method for monitoring a movable barrier system, the method comprising:
receiving data generated by a controller situated in a movable barrier operator, wherein the controller is connected to one or more sensors for generating one or more signals related to one or more parameters of the movable barrier system, and wherein the data generated by the controller pertains to the one or more parameters;
generating one or more outputs associated with the data received from the controller; and
displaying the one or more outputs on a touchscreen display of the movable barrier operator.

23. The touchscreen interface of claim 24, wherein the executed method of monitoring the movable barrier system further comprises:
receiving a user input for altering a value pertaining to the one or more parameters; and
generating a command signal for commanding the controller of the movable barrier operator to change the one or more parameters of the movable barrier system according to the user input.

24. The touchscreen interface of claim 25, wherein displaying the one or more outputs on the touchscreen display comprises:
displaying a screen output including one or more tabs for displaying one or more values pertaining to the one or more parameters of the movable barrier system.

25. The touchscreen interface of claim 26, wherein displaying the screen output including the one or more tabs comprises displaying a timer control panel for setting a functioning time of one or more components of the movable barrier system.

26. The touchscreen interface of claim 26, wherein displaying the screen output including the one or more tabs comprises displaying a settings control panel for altering the value of the one or more parameters of the movable barrier system.

27. The touchscreen interface of claim 26, wherein displaying the screen output including the one or more tabs comprises displaying a history access panel for accessing one or more events recorded by the movable barrier system.

28. The touchscreen interface of claim 26, wherein displaying the screen output including the one or more tabs comprises displaying a communications information panel for displaying one or more devices connected to the movable barrier system.

29. The touchscreen interface of claim 26, wherein displaying the screen output including the one or more tabs comprises displaying an inputs and limits control panel for displaying the status of one or more devices of the movable barrier system.
